(19) United States
(12) Patent Application Publication
(10) Pub. No.: US 2024/0276521 A1
(43) Pub. Date: Aug. 15, 2024

(54) RESOURCE EXCLUSION METHOD, RESOURCE RESELECTION METHOD AND APPARATUSES, TERMINAL, AND STORAGE MEDIUM

(71) Applicant: GUANGDONG OPPO MOBILE TELECOMMUNICATIONS CORP., LTD., Dongguan (CN)

(72) Inventors: Yi DING, Dongguan (CN); Shichang ZHANG, Dongguan (CN); Zhenshan ZHAO, Dongguan (CN); Huei-Ming LIN, South Yarra (AU)

(21) Appl. No.: 18/289,961

(22) PCT Filed: Sep. 25, 2020
(86) PCT No.: PCT/CN2020/117870

§ 371 Date: Apr. 17, 2024

(51) Int. Cl. H04W 72/25; H04L 5/00; H04W 72/02; H04W 72/044; H04W 72/566; H04W 92/18

(52) U.S. Cl. CPC H04W 72/25; H04L 5/0051; H04W 72/02; H04W 72/044; H04W 72/566; H04W 92/18

(57) ABSTRACT

Provided are a resource exclusion method, a resource reselection method and apparatuses, a device, and a storage medium, and relates to the technical field of mobile communications. The resource exclusion method includes that: a second terminal determines a slot set, the slot set including slots for a first terminal to send data; the second terminal determines resource exclusion reference information based on first Side Link Control Information (SCI) detected in the slot set; and the second terminal sends the resource exclusion reference information to the first terminal, the resource exclusion reference information being configured to assist the first terminal in resource exclusion.

### TECHNICAL FIELD

The disclosure relates to the technical field of mobile communications, and in particular, to a resource exclusion method, a resource reselection method and apparatuses, a terminal, and a storage medium.

### BACKGROUND

To achieve direct communication between terminals in a Vehicle to everything (V2X) system, a Side Link (SL) transmission manner is introduced.

In an SL transmission mode, a terminal needs to perform resource selection in a resource pool through a resource exclusion process and a resource selection process. Selected resources may be reserved by the terminal through sending Side Link Control Information (SCI) to other terminals. The reserved selected resources may be pre-empted by other terminals when data with higher priority needs to be sent by the other terminals.

A terminal may perform resource exclusion when triggering resource selection or resource reselection, and may also perform resource exclusion when re-evaluating selected and unindicated resources or determining whether selected and indicated resources are pre-empted by other terminals. In the resource exclusion process, the terminal may perform resource exclusion according to undetected slots, that is, since the terminal cannot perform resource monitoring when sending data, the terminal may perform resource exclusion based on all values for a resource reservation period set M in a resource pool configuration used by the terminal. The resource exclusion is performed based on all resource reservation period values, which may lead to excessive resource exclusion in the resource exclusion process.

### SUMMARY

Embodiments of the disclosure provide a resource exclusion method, a resource reselection method and apparatuses, a terminal, and a storage medium, which may avoid excluding excessive resources in a resource exclusion process through the cooperation between the terminals. The technical solutions are as follows.

An aspect of the disclosure provides a resource exclusion method, which is applied by a second terminal. The method may include the following operations.

The second terminal determines a slot set, the slot set including slots for a first terminal to send data; the second terminal determines resource exclusion reference information based on first sidelink control information (SCI) detected in the slot set; and the second terminal sends the resource exclusion reference information to the first terminal, the resource exclusion reference information being configured to assist the first terminal in resource exclusion.

An aspect of the disclosure provides a resource reselection method, which is applied by a cooperative terminal. The method may include the following operations.

A first resource set and a second resource set are determined, the first resource set including time-frequency resources for a first terminal to send data, and the second resource set including time-frequency resources for a second terminal to send data.

In response to the first resource set and the second resource set satisfying a resource conflict condition, resource reselection reference information is sent to the first terminal, the resource reselection reference information being configured to assist the first terminal in resource reselection.

An aspect of the disclosure provides a resource reselection apparatus, which may include a determination module and a sending module.

The determination module may be configured to determine a slot set, the slot set including slots for a first terminal to send data.

The determination module may further be configured to determine resource exclusion reference information based on first SCI detected in the slot set.

The sending module may be configured to send the resource exclusion reference information to the first terminal, the resource exclusion reference information being configured to assist the first terminal in resource exclusion.

An aspect of the disclosure provides a resource reselection apparatus, which may include a determination module and a sending module.

The determination module may be configured to determine a first resource set and a second resource set, the first resource set including time-frequency resources for a first terminal to send data, and the second resource set including time-frequency resources for a second terminal to send data.

The sending module may be configured to send, when the first resource set and the second resource set satisfy a resource conflict condition, resource reselection reference information to the first terminal, the resource reselection reference information being configured to assist the first terminal in resource reselection.

An aspect of the disclosure provides a terminal, which may include a processor, a transceiver connected to the processor, and a memory configured to store instructions executable by the processor. The processor may be configured to load and execute the executable instructions to implement the resource exclusion method or the resource reselection method as described in the above aspects.

An aspect of the disclosure provides a computer-readable storage medium, in which executable instructions are stored, the executable instructions being loaded and executed by a processor to implement the resource exclusion method or the resource reselection method as described in the above aspects.

An aspect of the disclosure provides a computer program product or a computer program, which may include computer instructions. The computer instructions may be stored in a computer-readable storage medium, read from the computer-readable storage medium by a processor of a computer device, and executed by the processor, so that the computer device performs the resource exclusion method or the resource reselection method as described in the above aspects.

Another aspect of the disclosure provides a chip, which may include a programmable logic circuit or a program. The chip may be configured to implement the resource exclusion method or the resource reselection method as described in the above aspects.

The technical solutions provided by the embodiments of the disclosure include at least the following beneficial effects.

Through the cooperation between the first terminal and the second terminal, the second terminal can help the first terminal determine the reference information needed for resource exclusion or resource reselection, and the first terminal may perform the resource exclusion or the resource reselection based on the reference information sent by the second terminal, thereby improving the utilization rate of communication resources and the communication reliability.

### BRIEF DESCRIPTION OF THE DRAWINGS

In order to more clearly illustrate the technical solutions in the embodiments of the disclosure, the drawings used in the description of the embodiments will be briefly described below. It is apparent that the drawings described below are only some embodiments of the disclosure. Other drawings may further be obtained by those of ordinary skill in the art according to these drawings without creative efforts.

FIG. 1 is a schematic diagram of an SL transmission mode in related technology of the disclosure.

FIG. 2 is a block diagram of a structure of a physical layer of a New Radio (NR)-V2X in related technology of the disclosure.

FIG. 3 is a block diagram when resource reservation is performed within a Transport Block (TB) or between TBs in related technology of the disclosure.

FIG. 4 is a schematic diagram of a resource selection method provided by an exemplary embodiment of the disclosure.

FIG. 5 is a schematic diagram of a resource selection method provided by an exemplary embodiment of the disclosure.

FIG. 6 is a schematic diagram of a resource re-evaluation process provided by an exemplary embodiment of the disclosure.

FIG. 7 is a schematic diagram of a resource pre-emption determination process provided by an exemplary embodiment of the disclosure.

FIG. 8 is a block diagram of a communication system supporting SL transmission provided by an exemplary embodiment of the disclosure.

FIG. 9 is a flowchart of a resource exclusion method provided by an exemplary embodiment of the disclosure.

FIG. 10 is a flowchart of a resource exclusion method provided by an exemplary embodiment of the disclosure.

FIG. 11 is a time-frequency resource diagram of a resource exclusion method provided by an exemplary embodiment of the disclosure in exemplary implementation.

FIG. 12 is a flowchart of a resource exclusion method provided by an exemplary embodiment of the disclosure.

FIG. 13 is a time-frequency resource diagram of a resource exclusion method provided by an exemplary embodiment of the disclosure in exemplary implementation.

FIG. 14 is a flowchart of a resource exclusion method provided by an exemplary embodiment of the disclosure.

FIG. 15 is a time-frequency resource diagram of a resource exclusion method provided by an exemplary embodiment of the disclosure in exemplary implementation.

FIG. 16 is a schematic diagram of bit ordering of a resource reservation period set and a resource set provided by an exemplary embodiment of the disclosure.

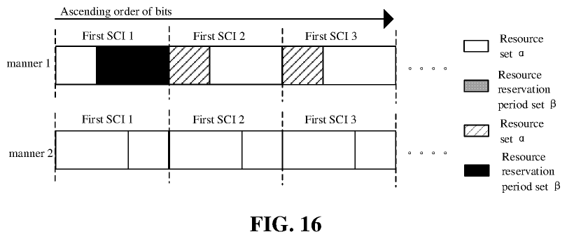

FIG. 17 is a flowchart of a resource reselection method provided by an exemplary embodiment of the disclosure.

FIG. 18 is a flowchart of a resource reselection method provided by an exemplary embodiment of the disclosure.

FIG. 19 is a flowchart of a resource reselection method provided by an exemplary embodiment of the disclosure.

FIG. 20 is a structural block diagram of a resource exclusion apparatus provided by an exemplary embodiment of the disclosure.

FIG. 21 is a structural block diagram of a resource reselection apparatus provided by an exemplary embodiment of the disclosure.

FIG. 22 is a schematic structural diagram of a communication device provided by an exemplary embodiment of the disclosure.

### DETAILED DESCRIPTION

In order to make the objectives, technical solutions, and advantages of the disclosure clearer, the implementations of the disclosure will be further described below in detail in combination with the drawings.

First, terms involved in the embodiments of the disclosure are briefly introduced.

V2X (Vehicle to everything) is a key technology for future intelligent transportation systems, which mainly studies vehicle data transmission solutions based on a 3rd Generation Partnership Project (3GPP) communication protocol. V2X communication includes Vehicle to Vehicle (V2V) communication, Vehicle to Infrastructure (V2I) communication, and Vehicle to People (V2P) communication. V2X applications may improve the driving safety, reduce the congestion and the vehicle energy consumption, and improve the traffic efficiency.

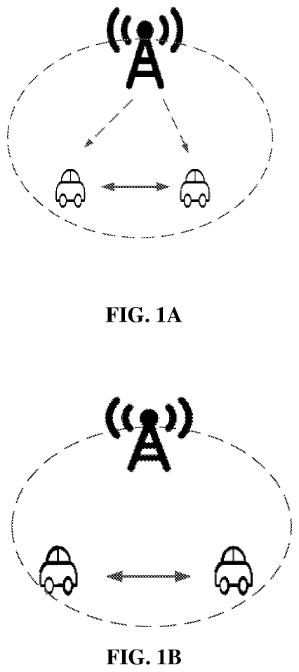

SL (Side Link) transmission is a device-to-device communication mode having higher spectral efficiency and lower transmission latency. Two SL transmission modes, namely mode A and mode B, are defined in the 3GPP. As shown in FIG. 1A, in the mode A, resources used by a terminal during transmission are assigned by a base station through a downlink, and the terminal may send data on an SL based on the resources assigned by the base station. The base station may allocate resources for the terminal for single transmission or semi-static transmission. As shown in FIG. 1B, in the mode B, the terminal may select one or more resources from a resource pool for data transmission. Specifically, the terminal may select transmission resources from the resource pool in a monitoring manner or a random selection manner. Namely, an SL is used for communication in V2X.

Self-driving is required to be supported in NR (New Radio)-V2X, so that higher requirements for data interaction between vehicles are put forward, such as higher throughput, lower latency, higher reliability, larger coverage, and more flexible resource assignment.

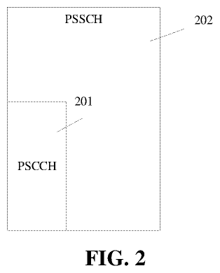

The structure of a physical layer of NR-V2X is as shown in FIG. 2. A Physical Side-Link Control Channel (PSCCH) 201 for transmitting control information is included in a Physical Side-Link Shared Channel (PSSCH) 202 for transmitting data, which means that the PSCCH 201 and the PSSCH (PSSCH) 202 are required to be sent at the same time. In the mode B of NR-V2X, the terminal may select resources from a resource pool to send data. Resource reservation is the premise of resource selection, and refers to reservation of resources to be used next when the terminal sends first SCI in the PSCCH. NR-V2X supports both resource reservation within a single TB and resource reservation between two TBs. The PSSCH scheduled by the first SCI transmitted in the PSCCH in FIG. 2 by the terminal refers to the PSSCH sent by the terminal at the same time as the PSCCH in FIG. 2.

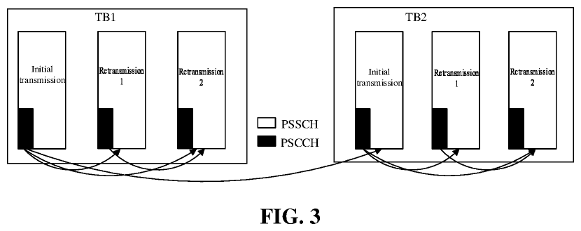

The terminal may send first SCI, and use “Time resource assignment” and “Frequency resource assignment” fields in the first SCI to indicate N time-frequency resources of a current TB (including resources for current transmission), where N≤Nₘₐₓ, and in NR-V2X, Nₘₐₓ is equal to 2 or 3. The above N indicated time-frequency resources should be distributed in W slots. In NR-V2X, W is equal to 32. For example, in TB 1 of FIG. 3, when sending initial transmission data on a PSSCH, the terminal sends first SCI in the PSCCH, and uses the above two fields to indicate time-frequency resource locations of initial transmission, retransmission 1, and retransmission 2 (that is, N=3), that is, time-frequency resources of the retransmission 1 and the retransmission 2 are reserved. In addition, the initial transmission, the retransmission 1, and the retransmission 2 are distributed in 32 slots in time domain.

When sending the first SCI, the terminal may use a “Resource reservation period” field to reserve resources between TBs. For example, in FIG. 3, when sending first SCI for initial transmission of TB 1, the terminal uses the “Time resource assignment” and “Frequency resource assignment” fields to indicate the time-frequency resource locations of the initial transmission, the retransmission 1, and the retransmission 2 of the TB 1, marked as {(t1, f1), (t2, f2), (t3, f3)}, where t1, t2, and t3 represent the time domain locations of resources for the initial transmission, the retransmission 1, and the retransmission 2 of the TB 1, and f1, f2, and f3 represent the corresponding frequency domain locations. If a value of the “Resource reservation period” field in the SCI is 100 milliseconds, the SCI indicates that three time-frequency resources {(t1+100, f1), (t2+100, f2), (t3+100, f3)} are reserved, which are configured for the initial transmission, the retransmission 1, and the retransmission 2 of TB 2. In NR-V2X, the value of the “Resource reservation period” field may be 0, 1-99, 100, 200, 300, 400, 500, 600, 700, 800, 900, or 1000 milliseconds, which is more flexible than Long Term Evolution (LTE) V2X. However, in each resource pool, only e types of values are configured, and the terminal may determine possible values based on the resource pool used. The e types of values in a resource pool configuration are marked as a resource reservation period set M, for example, e is less than or equal to 16. The resource reservation period is a value indicated by the “Resource reservation period” field.

In addition, based on a network configuration or a pre-configuration, reservation between TBs may be activated or deactivated in units of resource pools. When the reservation between the TBs is deactivated, the “Resource reservation period” field is not included in the first SCI. Under normal circumstances, before the resource reselection is triggered, the value of the “Resource reservation period” field used by the terminal, namely the resource reservation period, does not change. Every time the terminal sends the first SCI, the “Resource reservation period” field therein is used to reserve resources for the next period for the transmission of another TB, thereby achieving periodic semi-continuous transmission.

When the terminal works in the mode B, the terminal may acquire first SCI from other terminals by monitoring a PSCCH sent by other terminals, so as to know resources reserved by other terminals. When performing resource selection, the terminal may exclude the resources reserved by other terminals, thereby avoiding a resource collision.

A resource selection method in NR-V2X includes the following operations.

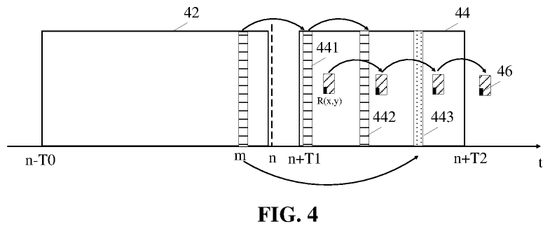

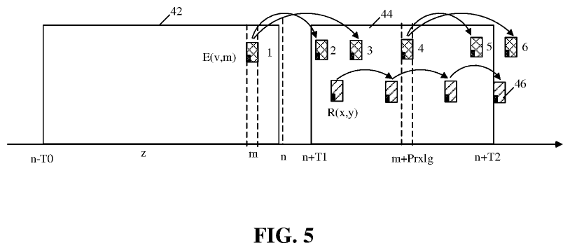

As shown in FIG. 4 and FIG. 5, a resource selection window (selection window for short) starts from a time point n+T1 and ends at a time point n+T2.

T1 is greater than or equal to 0, and T1 is less than or equal to T_{proc,1}. T_{proc,1} includes time for terminal 1 to perform resource selection and data preparation. When subcarrier intervals are 15, 30, 60, and 120 kHz, T_{proc,1} corresponds to 3, 5, 9, and 17 slots, and T2 is greater than or equal to T2ₘᵢₙ, and T2 is less than or equal to a remaining delay budget of a service. A value set of T2ₘᵢₙ is {1, 5, 10, 20}*2^{μ} slots, where μ=0, 1, 2, and 3 respectively correspond to the cases where subcarrier intervals are 15 kHz, 30 kHz, 60 kHz, and 120 kHz, and the terminal 1 determines T2ₘᵢₙ from the value set according to priority of data to be sent. When T2ₘᵢₙ is greater than the remaining delay budget of the service, T2 is equal to the remaining delay budget of the service.

The remaining delay budget is a difference between a delay requirement of data and a current time point. For example, for a data packet arriving in slot n, the delay requirement is 50 milliseconds; assuming that a slot is 1 millisecond, if the current time point is slot n, then the remaining delay budget is 50 milliseconds; and if the current time point is slot n+20, then the remaining delay budget is 30 milliseconds.

The terminal 1 performs resource monitoring from time point n-TO to time point n-T_{proc,0}, the value of TO is 100 or 1100 milliseconds. T_{proc,0} includes time for the terminal to decode control information. When subcarrier intervals are 15, 30, 60, and 120 kHz, T_{proc,0} is 1, 1, 2, and 4 slots, respectively.

### At Operation 1, Resource Exclusion is Performed.

Assuming that terminal 1 takes all available resources belonging to a resource pool used by the terminal 1 within resource selection window 44 as resource set A when the terminal 1 needs to perform resource selection or resource reselection, any resource in the resource set A is marked as R(x, y), where x and y indicate a frequency domain location and a time domain location of the resource respectively. The initial number of all the available resources belonging to the resource pool used by the terminal 1 within the resource selection window 44 is marked as Mₜₒₜₐₗ.

At operation 1-1, if the terminal 1 sends data in the slot m within resource monitoring window 42 without performing monitoring, the terminal 1 may determine whether the slot m+q*Prxlg overlaps with resource R(x, y+j*Ptxlg), and if they overlap, the terminal 1 excludes the resource R(x,y) from the resource set A, where j=0, 1, 2, 3, . . . , C−1, and C is determined by a random counter value generated by the terminal 1. When the terminal 1 performs resource selection, a counter value (a positive integer) is randomly generated to determine how many periods are reserved for resources to be selected. Ptxlg is the number of logical slots converted from Ptx, and Ptx is the resource reservation period determined by the terminal 1, is one of the values in the resource reservation period set M in the resource pool configuration used by the terminal 1, and is also a value to be indicated by the “Resource reservation period” field in the first SCI of the terminal 1 when the terminal 1 sends the data after completing resource selection. Therefore, the resource R(x, y+j*Ptxlg) is a series of resources 46 marked by a diagonal shadow in FIG. 4. For the slot m+q*Prxlg, where q=1, 2, 3, . . . , Q, and Prxlg is the number of logical slots converted from Prx. Prx is the resource reservation period indicated by the “Resource reservation period” field in the first SCI transmitted in the PSCCH detected by the terminal 1. Since the terminal 1 does not perform monitoring in the slot m, Prx here refers to all possible values of the resource reservation period set M in the resource pool configuration used by the terminal 1, that is, the terminal 1 determines whether the slot m+q*Prxlg calculated by each value in M overlaps with the resource R(x, y+j*Ptxlg). For Q, if Prx is less than Tscal and n-m is less than or equal to Prxlg, Q=[Tscal/Prx] (representing rounding up), otherwise Q=1. Tscal is equal to a value after T2 is converted to milliseconds. For example, the terminal 1 does not perform monitoring in the slot m, and sequentially selects one Prx from the resource reservation period set M in the resource pool configuration used for resource exclusion. For a certain Prx, if Prx is less than Tscal and n-m is less than or equal to Prxlg, assuming that a Q value is calculated to be 2, the slot m+q*Prxlg is the slots 441 and 442 identified by the next two horizontal line shadows mapped by the slot m in FIG. 4, otherwise Q=1, and the slot m+q*Prxlg is the slot 443 identified by a dotted shadow in FIG. 4.

At operation 1-2, as shown in FIG. 5, if the terminal 1 detects the first SCI transmitted in the PSCCH on resource E(v, m) in the slot m within the resource monitoring window 42 (v is the frequency domain location of the resource), SL-Reference Signal Received Power (RSRP) of the PSCCH or SL-RSRP of a PSSCH scheduled by the PSCCH (that is, the SL-RSRP of the PSSCH which is sent at the same time as the PSCCH) is measured. If the measured SL-RSRP is greater than an SL-RSRP threshold, and the resource pool used by the terminal 1 activates resource reservation between TBs, the terminal 1 is assumed to receive the first SCI having the same content in the slot m+q*Prxlg, where q=1,2,3, . . . , Q. For Q, if Prx is less than Tscal and n-m is less than or equal to Prxlg, Q=[Tscal/Prx] (representing rounding up), otherwise Q=1. Tscal is equal to a value after T2 is converted to milliseconds. Prxlg is the number of logical slots converted from Prx, and Prx is the resource reservation period indicated by the “Resource reservation period” in the first SCI transmitted in the PSCCH detected by the terminal 1. The terminal 1 may determine whether resources indicated by the “Time resource assignment” and “Frequency resource assignment” fields of the first SCI received in the slot m and Q pieces of first SCI assumed to be received overlap with the resource R(x, y+j*Ptxlg), and if overlapping, the terminal 1 excludes the corresponding resource R(x, y) from the resource set A. The above j=0, 1, 2, 3, . . . , C−1, and C is determined by a random counter value generated by the terminal. Ptxlg is the number of logical slots converted from Ptx, and Ptx is the resource reservation period determined by the terminal 1. For example, the resource R(x, y+j*Ptxlg) is four resources 46 marked by the diagonal shadow in FIG. 5.

If the terminal 1 detects the first SCI in the PSCCH on the resource E(v, m) in the slot m, decodes that Prx is greater than Tscal and calculates that Q is equal to 1, the terminal 1 may be assumed to receive first SCI having the same content in the slot m+Prxlg. The terminal 1 may determine whether resources 1, 2, 3, 4, 5, and 6 (the resource 1 and the resource E(v, m) refer to the same resource) indicated by the “Time resource assignment” and “Frequency resource assignment” fields of the first SCI received in the slot m and the first SCI assumed to be received in the slot m+Prxlg overlap with the resource R(x, y+j*Ptxlg), and if overlapping, then the terminal 1 excludes the resource R(x, y) from the resource set A. If the SL-RSRP measured by the terminal 1 is greater than the SL-RSRP threshold, and the resource pool used by the terminal 1 deactivates resource reservation between TBs, then the terminal 1 may only determine whether the resources indicated by the “Time resource assignment” and “Frequency resource assignment” fields of the first SCI received in the slot m overlap with the resource R(x, y+j*Ptxlg), and if overlapping, then the terminal 1 excludes the corresponding resource R(x, y) from the resource set A.

If the remaining resources in the resource set A after the resource exclusion are less than Mₜₒₜₐₗ*X %, the SL-RSRP threshold is increased by 3 dB and the operation 1 (including at least one of the operation 1-1 or operation 1-2) is executed again. The physical layer reports the resource set A subjected to the resource exclusion as a candidate resource set to the higher layer.

### At Operation 2, Resource Selection is Performed.

After the resource exclusion, the terminal 1 randomly selects multiple resources from the candidate resource set A as resources for the terminal 1 to send data.

It is to be noted that:
1. The above RSRP threshold is determined by priority P1 carried in the PSCCH detected by the terminal 1 and priority P2 of data to be sent by the terminal 1. The terminal 1 acquires an SL-RSRP threshold table through a network configuration or a pre-configuration. The SL-RSRP threshold table contains SL-RSRP thresholds corresponding to all priority combinations.

For example, as shown in Table 1, assuming that optional values of the priority P1 and priority P2 are 0 to 7, the SL-RSRP thresholds corresponding to different priority combinations may be represented by γᵢⱼ, where i in the γᵢⱼ is the value of the priority P1, and j is the value of the priority P2.

TABLE 1

P1

| P2 | 0 | 1 | 2 | 3 | 4 | 5 | 6 | 7 |
|---|---|---|---|---|---|---|---|---|
| 0 | γ₀₀ | γ₀₁ | γ₀₂ | γ₀₃ | γ₀₄ | γ₀₅ | γ₀₆ | γ₀₇ |
| 1 | γ₁₀ | γ₁₁ | γ₁₂ | γ₁₃ | γ₁₄ | γ₁₅ | γ₁₆ | γ₁₇ |
| 2 | γ₂₀ | γ₂₁ | γ₂₂ | γ₂₃ | γ₂₄ | γ₂₅ | γ₂₆ | γ₂₇ |
| 3 | γ₃₀ | γ₃₁ | γ₃₂ | γ₃₃ | γ₃₄ | γ₃₅ | γ₃₆ | γ₃₇ |
| 4 | γ₄₀ | γ₄₁ | γ₄₂ | γ₄₃ | γ₄₄ | γ₄₅ | γ₄₆ | γ₄₇ |
| 5 | γ₅₀ | γ₅₁ | γ₅₂ | γ₅₃ | γ₅₄ | γ₅₅ | γ₅₆ | γ₅₇ |
| 6 | γ₆₀ | γ₆₁ | γ₆₂ | γ₆₃ | γ₆₄ | γ₆₅ | γ₆₆ | γ₆₇ |
| 7 | γ₇₀ | γ₇₁ | γ₇₂ | γ₇₃ | γ₇₄ | γ₇₅ | γ₇₆ | γ₇₇ |

When the terminal 1 detects the PSCCH sent by terminal 2, the terminal 1 acquires the priority P1 carried in the first SCI transmitted in the PSCCH and the priority P2 of a data packet to be sent, and the terminal 1 determines the SL-RSRP threshold by looking up Table 1.
2. Whether the terminal 1 uses the measured PSCCH-RSRP or the PSSCH-RSRP scheduled by the PSCCH to compare with the SL-RSRP threshold depends on the resource pool configuration of the resource pool used by the terminal 1. The resource pool configuration may be a network configuration or a pre-configuration.
3. With respect to the above Prxlg/Ptxlg, which are the number of logical slots converted from Prx/Ptx respectively: assuming that a slot is equal to 1 millisecond and Prx is 5 milliseconds, in these 5 slots, 2 slots may be downlink slots in a Time Division Duplexing (TDD) mode or slots for transmitting synchronization signals, and the 2 slots are not included in the resource pool of an SL, so that it is necessary to convert 5 milliseconds represented by Prx into 3 logical slots, namely Prxlg.
4. With respect to the above X %, the value of X may be {20,35,50}. The resource pool configuration used by the terminal 1 contains corresponding relationships between priority and the above possible values. The terminal 1 determines the value of X according to priority of data to be sent and the corresponding relationships. The resource pool configuration may be a network configuration or a pre-configuration.

Re-evaluation and pre-emption mechanisms are as follows.

In addition, NR-V2X also supports re-evaluation of a first selected resource that is not yet indicated by sending first SCI after the resource selection is completed.

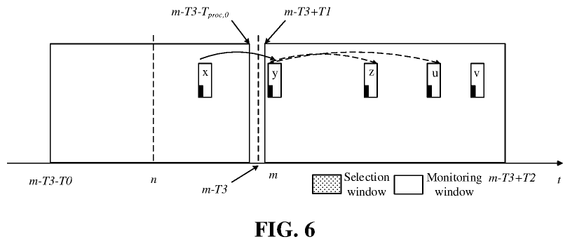

As shown in FIG. 6, resources x, y, z, u, and v are selected resources selected by the terminal 1 in the slot n, and the resource y is located in the slot m. For the resources z and u which are first indicated by the first SCI to be sent by the terminal 1 on the resource y (the resource y has been indicated by the first SCI in the resource x), the terminal 1 performs resource exclusion in the above operation 1 at least once in the slot m-T3, that is, at least in the slot m-T3 according to the above determined resource selection window and resource monitoring window, and the above operation 1 is implemented to perform resource exclusion on the resources within the resource selection window to obtain a candidate resource set. If the resource z or u is not in the candidate resource set, the terminal 1 executes the above operation 2 to reselect time-frequency resources from the resources z and u, which are not in the candidate resource set, or reselect any resource, which has been selected but not indicated by sending the first SCI, such as any number of resources in the resources z, u and v. The above T3 is equal to T_{proc,1}. In FIG. 6, a dotted arrow indicates that an indication of the first SCI is about to be sent, and a solid arrow indicates that the indication of the first SCI has been sent.

NR-V2X also supports a resource pre-emption mechanism. In NR-V2X, conclusions about the resource pre-emption mechanism are described from the perspective of a pre-empted terminal. After the resource selection is completed, the terminal 1 continues to monitor the first SCI. If the selected resource indicated by sending the first SCI satisfies the following three conditions, it means that the selected resource is pre-empted by other terminals, and the terminal 1 triggers resource reselection for the selected resource.
Condition 1: resources reserved in detected first SCI overlap with selected resources indicated by the terminal 1, including full overlap and partial overlap.
Condition 2: an SL-RSRP of a PSCCH corresponding to first SCI detected by the terminal 1 or an SL-RSRP of a PSSCH scheduled by the PSCCH is greater than an SL RSRP threshold.
Condition 3: priority carried in detected first SCI is higher than priority of data to be sent by the terminal 1.

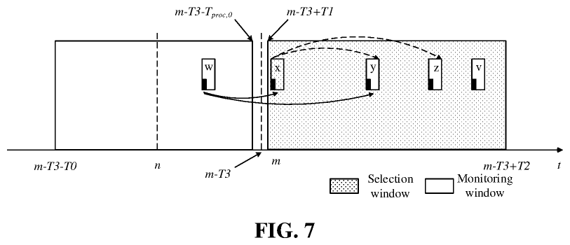

As shown in FIG. 7, resources w, x, y, z, and v are time-domain resources that have been selected by the terminal 1 in slot n, and the resource x is located in slot m. For the resources x and y that are indicated by first SCI to be sent by the terminal 1 on the resource x and have been indicated by first SCI previously sent by the terminal 1, the terminal 1 executes the above operation 1 at least once in the slot m-T3, that is, at least in the slot m-T3 according to the determined resource selection window and monitoring window, and the terminal 1 implements the above operation 1 to perform resource exclusion on the resources within the resource selection window to determine a candidate resource set. If the resource x or y is not in the candidate resource set (satisfying the above conditions 1 and 2), it is further determined whether the indication of the first SCI carrying high priority (higher than priority of data to be sent by the terminal 1) causes the resource x or y to be not in the candidate resource set (satisfying the above condition 3), and if such cause stands, the terminal 1 executes operation 2 to reselect time-frequency resources that satisfy the above three conditions from the resources x and y. In addition, when resource reselection is triggered, the terminal 1 may reselect any resource that has been selected but not indicated by sending the first SCI, such as any number of resources z and v. The above T3 is equal to T_{proc,1}.

The above SL-RSRP is a linear average of received power over all Resource Elements (REs) carrying a reference signal (Demodulation Reference Signal (DMRS) or Channel State Information-Reference Signal (CSI-RS) in the PSCCH or the PSSCH. When the PSSCH or PSSCH is transmitted using multiple antenna ports, the SL-RSRP is the sum of the SL-RSRP measured by various antenna ports.

According to the above, the first SCI is carried in the PSCCH, and mainly contains fields related to resource monitoring, which facilitates other terminals to perform resource exclusion and resource selection after decoding. In addition to data, second SCI is also carried in the PSSCH, and mainly includes fields related to data demodulation, which facilitates other terminals to demodulate the data in the PSSCH. The second SCI is classified into two formats, marked as SCI format 2-A and SCI format 2-B. There are “Source Identifier (ID)” and “Destination ID” fields in the above two formats, the former is an ID of a terminal that sends data scheduled by the second SCI, and the latter is an ID of a terminal that receives the data scheduled by the second SCI. The above data scheduled by the second SCI refers to the data that is carried in the same PSSCH as the second SCI.

A “cast type indicator” field in SCI format 2-A is configured to indicate a transmission type of the data in the PSSCH carrying the second SCI, including unicast, multicast, broadcast, and multicast with feedback Negative Acknowledgment (NACK) only. The multicast with feedback NACK only means that a terminal sends the data to a group of terminals, and only the terminals that fail to decode the data feed NACK back to the sending terminal.

There are “Zone ID” and “Communication range requirement” fields in SCI format 2-B. In NR-V2X, a certain zone is allowed to be divided into multiple small zones, and each small zone is marked as Zone. Therefore, the “Zone ID” refers to an ID of a small zone where a terminal sending the second SCI is located. The “Communication range requirement” field indicates a distance, which represents how far away from the terminal sending the data a terminal needs to feed Hybrid Automatic Repeat reQuest (HARQ) information back to the sending terminal. It may also be understood that the terminals within the indicated distance are all receiving objects of the terminal sending the data.

The terminal monitors or blind detects the first SCI in the PSCCH sent by a terminal in a current slot, decodes the second SCI in the PSSCH sent by the same terminal and transmitted at the same time as the PSCCH based on the indication of the first SCI, and then decodes the data in the PSSCH based on the indication of the second SCI.

The disclosure introduces a cooperative mechanism between User Equipments (UEs) to solve the above problems.

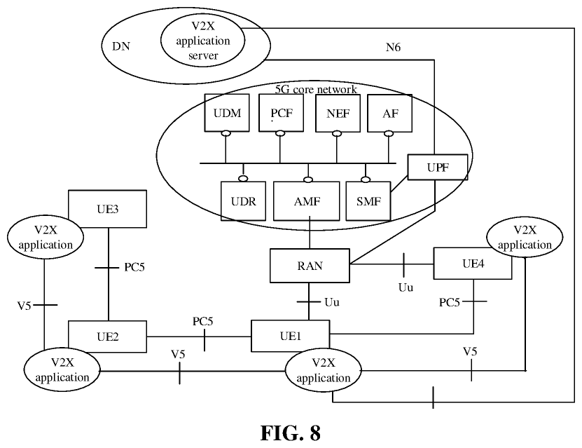

FIG. 8 illustrates a block diagram of a communication system supporting SL transmission provided by an exemplary embodiment of the disclosure. The communication system may be a schematic diagram of a non-roaming 5th Generation (5G) system architecture, which may be applied to V2X services using a D2D technology.

The system architecture includes a Data Network (DN), which is provided with a V2X application server required for the V2X services. The system architecture further includes a 5G core network, and network functions of the 5G core network include: a Unified Data Management (UDM) function, a Policy Control Function (PCF), a Network Exposure Function (NEF), an Application Function (AF), a Unified Data Repository (UDR) function, an Access and Mobility Management Function (AMF), a Session Management Function (SMF), and a User Plane Function (UPF).

The system architecture further includes a New Generation-Radio Access Network (NG-RAN) and four exemplary terminals (i.e., terminals 1 to 4), each of which is provided with a V2X application. RAN is provided with one or more access network devices, such as a base station (gNB). The terminal may perform uplink transmission on the access network device.

In the system architecture, the DN may be connected to the UPF in the 5G core network through an N6 reference point, and the V2X application server may be connected to the V2X application in the terminal through a V1 reference point. The RAN may be connected to the AMF and the UPF in the 5G core network, and the RAN may be respectively connected to the terminal 1 and the terminal 5 through a Uu reference point. Multiple terminals may perform SL transmission through a PC5 reference point, and multiple V2X application may be connected through a V5 reference point. The above reference points may also be referred to as “interfaces”.

The embodiments of the disclosure provide two different cooperative modes between the UEs: a cooperative mode between UEs for resource exclusion and a cooperative mode between UEs for resource reselection process.
The cooperative mode between UEs for resource exclusion:

A second terminal determines slots for a first terminal to send data, marked as slot set A. The second terminal determines resource set α and/or resource reservation period set 3 based on first SCI detected in the slot set A and indicates the resource set α and/or the resource reservation period set 3 to the first terminal. The first terminal performs resource exclusion based on the resource set α and/or the resource reservation period set 3 indicated by the second terminal.
The cooperative mode between UEs for resource reselection:

A cooperative terminal determines time-frequency resources for a first terminal to send data, marked as slot set φ. The cooperative terminal determines time-frequency resources for a second terminal to send data, marked as slot set θ. If the resources in the resource set φ and the resource set β satisfy a first condition, the cooperative terminal instructs the first terminal to perform resource reselection, or the cooperative terminal instructs the second terminal to perform resource reselection. Or, the cooperative terminal determines time-frequency resources for the first terminal to send data, marked as slot set φ. The cooperative terminal determines time-frequency resources for the second terminal to send data, marked as slot set θ. If the resources in the resource set φ and the resource set β satisfy a second condition, the cooperative terminal instructs the first terminal to perform resource reselection.

### The Cooperative Mode Between UEs for Resource Exclusion Provides the Following Embodiment.

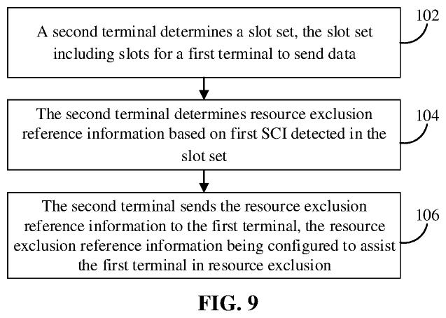

FIG. 9 illustrates a flowchart of a resource exclusion method provided by an exemplary embodiment of the disclosure. The embodiment is exemplified by applying the method to the second terminal (i.e., terminal 2) in FIG. 8. The method includes the following operations.

At operation 102, the second terminal determines a slot set, the slot set including slots for a first terminal to send data.

The second terminal determines the slots in which the first terminal sends data.

In an example, the second terminal performs resource monitoring, that is, decoding first SCI sent by other terminals, in each slot (or slots other than a slot in which the second terminal sends data).

In a certain slot, the second terminal may decode corresponding second SCI sent by a certain terminal based on an indication or scheduling of the detected first SCI sent by the terminal. If a sender ID (source ID) field in the second SCI represents the first terminal, that is, the terminal is the first terminal, the second terminal determines that the first terminal sends data in a current slot, that is, the current slot is the slot in which the first terminal sends the data. Or, in a certain slot, the second terminal receives the data sent by the first terminal, and then the second terminal determines that the slot is the slot in which the first terminal sends the data.

The second terminal may mark the determined slot in which the first terminal sends the data as the slot set A, the slot set A including one or more slots in which the first terminal sends the data. “One or more” herein means at least one or more than one.

At operation 104, the second terminal determines resource exclusion reference information based on the first SCI detected in the slot set.

In an example, the first SCI detected in the slot set may include first SCI sent by other terminals. Other terminals are terminals other than the first terminal and the second terminal. In some embodiments, the first SCI may further include first SCI sent by the first terminal.

In an example, the first SCI is configured to indicate time-frequency resources indicated or reserved by other terminals.

The first SCI may include: a time-domain resource assignment field and a frequency-domain resource assignment field. Optionally, the first SCI may further include a resource reservation period field. The second terminal may determine the resource exclusion reference information based on at least one of the time-domain resource assignment field, the frequency-domain resource assignment field, or the resource reservation period field.

In an example, since the first terminal cannot monitor the first SCI sent by other terminals in the slot in which the first terminal sends the data, the resource exclusion reference information is information that cannot be monitored by the first terminal.

At operation 106, the second terminal sends the resource exclusion reference information to the first terminal.

The resource exclusion reference information is configured to assist the first terminal in resource exclusion. Or, the resource exclusion reference information is used as reference information when the first terminal performs resource exclusion. Or, the resource exclusion reference information is configured to help the first terminal perform resource exclusion. Or, the resource exclusion reference information is configured to trigger the first terminal to perform resource exclusion. However, whether the first terminal performs resource exclusion is determined by the first terminal.

In conclusion, according to the method provided by the embodiment, through the cooperation between the first terminal and the second terminal, the second terminal can help the first terminal determine reference information needed for resource exclusion, and the first terminal may perform the resource exclusion based on the resource exclusion reference information sent by the second terminal, so that the problem that the first terminal may exclude excessive resources when using all possible resource reservation periods for resource exclusion can be avoided, thereby enabling the first terminal to reserve enough available resources after the resource exclusion process, improving the utilization rate of communication resources. and improving the transmission success rate and transmission timeliness of the first terminal.

In an optional embodiment based on FIG. 9, the resource exclusion reference information may be implemented as the following three cases:
Resource reservation period set β

The resource reservation period set β includes: resource reservation periods indicated by the first SCI; or, resource reservation periods indicated by the first SCI detected by the second terminal; or, resource reservation periods at least indicated by other terminals; or, resource reservation periods at least indicated by other terminals through the first SCI.
Resource set α

The resource set α includes: resources indicated or reserved by the first SCI; or, resources indicated or reserved by the first SCI detected by the second terminal; or, resources at least indicated or reserved by other terminals; or, resources at least indicated or reserved by other terminals through the first SCI. The “resource” herein is short for time-frequency resource.
Resource reservation period set β+Resource set α.
   For a Case where the Resource Exclusion Reference Information Includes the Resource Reservation Period Set β

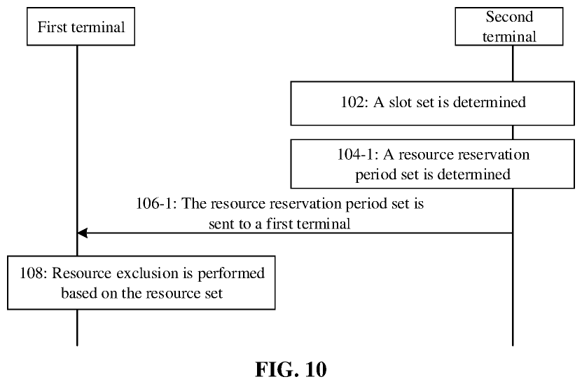

FIG. 10 illustrates a flowchart of a resource exclusion method provided by an exemplary embodiment of the disclosure. The embodiment is exemplified by application of the method to the second terminal (i.e., terminal 2) in FIG. 8. The above operation 104 may be replaced with operation 104-1, and the above operation 106 may be replaced with operation 106-1. The method includes the following operations.

At 104-1, the second terminal determines a resource reservation period set, the resource reservation period set including values indicated by the resource reservation period fields in the first SCI detected in the slot set.

The second terminal may determine the resource reservation period set β based on the first SCI detected in the slot set A. In an example, the second terminal may determine the resource reservation period set β based on the resource reservation period fields in the first SCI detected in the slot set A. In an example, the resource reservation period set β may include information bits in the resource reservation period field of the first SCI detected by the second terminal in the slot set A.

In an example, the second terminal may determine a first resource reservation period set, the first resource reservation period set including values indicated by the resource reservation period fields in all the first SCI detected in the slot set A.

In an example, the second terminal may determine a second resource reservation period set, the second resource reservation period set including values indicated by the resource reservation period fields in part of the first SCI detected in the slot set A. For example, the second resource reservation period set may include values of the resource reservation period fields indicated by target first SCI detected in the slot set A, where SL-RSRP of a PSCCH where the target first SCI is located is greater than an RSRP threshold or SL-RSRP of a PSSCH scheduled by the target first SCI is greater than the RSRP threshold.

The above RSRP threshold is implemented depending on the second terminal, or, the RSRP threshold is a configured by network threshold, or the RSRP threshold is a pre-configured threshold. The pre-configured threshold is a threshold set when delivery, or, the pre-configured threshold is a threshold that is configured by a previous network device and is still used by the second terminal after leaving cell coverage of the previous network device. Or, the above RSRP threshold is a preset value specified by the communication standard.

At operation 106-1, the second terminal sends the resource reservation period set to the first terminal, the resource reservation period set being configured to assist the first terminal to perform resource exclusion.

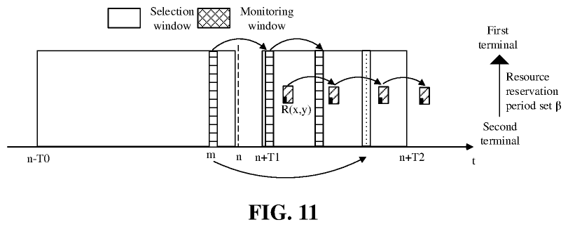

The second terminal indicates the resource reservation period set β to the first terminal. For example, in FIG. 11, the slot set A includes slot m, the slot m being a slot in which the first terminal sends data. The second terminal determines the resource reservation period set 3 based on the first SCI detected in the slot m in the above manner and indicates the resource reservation period set 3 to the first terminal.

The resource reservation period set 3 may be carried by at least one of following information:
PC5-Radio Resource Control (RRC) signaling;
a Medium Access Control Control Element (MAC CE);
first SCI; or
second SCI.

The first SCI is SCI carried in a PSCCH, and the second SCI is SCI carried in a PSSCH.

The second terminal may send the resource reservation period set 3 to the first terminal periodically. Or, in response to receiving trigger information of the first terminal, the second terminal may send the resource reservation period set 3 to the first terminal.

At operation 108, the first terminal performs the resource exclusion based on the resource reservation period set.

The first terminal receives the resource reservation period set 3 and performs the resource exclusion process based on the resource reservation period set.

When the first terminal performs the resource exclusion, in operation 1-1 of the resource exclusion process, the first terminal may determine whether slot m+q*Prxlg overlaps with resource R(x, y+j*Ptxlg), and if they overlap, the first terminal may exclude resource R(x, y) from resource set A. The manner of determining the resource R(x, y+j*Ptxlg) is consistent with operation 1-1 of the original resource exclusion process, that is, the resource identified by the diagonal shadow in FIG. 11. For the slot m+q*Prxlg, q=1, 2, 3, . . . , Q, and Prxlg is the number of logical slots converted from Prx. Prx refers to all the resource reservation periods in the resource reservation period set 3 indicated by the second terminal, that is, the first terminal determines whether the slot m+q*Prxlg calculated by each value in the resource reservation period set 3 overlaps with the resource R(x, y+j*Ptxlg). For Q, if Prx is less than Tscal and n-m is less than or equal to Prxlg, Q=[Tscal/Prx] (representing rounding up), otherwise Q=1. Tscal is equal to a value after T2 is converted to milliseconds.

For example, the first terminal does not perform monitoring in the slot m, and sequentially selects one Prx from the resource reservation period set 3 indicated by the second terminal for resource exclusion. For a certain Prx, if the Prx is less than Tscal and n-m is less than or equal to Prxlg, assuming that a Q value is calculated to be 2, the slot m+q*Prxlg is slots identified by the next two horizontal line shadows mapped by the slot m in FIG. 11, otherwise the Q value is calculated to be 1, and the slot m+q*Prxlg is a slot identified by a dotted shadow in FIG. 11. That is, when the first terminal performs resource exclusion based on the unmonitored slot, the resource reservation period set M in a resource pool configuration is replaced with the resource reservation period set 3.

In conclusion, according to the method provided by the embodiment, through the cooperation between the first terminal and the second terminal, the second terminal can help the first terminal determine the resource reservation period set β needed for the resource exclusion process, and the first terminal may perform the resource exclusion based on the resource reservation period set β sent by the second terminal, so that the problem that the first terminal may exclude excessive resources when using all possible resource reservation periods for resource exclusion can be avoided, thereby enabling the first terminal to reserve enough available resources after the resource exclusion process, improving the utilization rate of communication resources, and improving the transmission success rate and transmission timeliness of the first terminal.

For a Case where the Resource Exclusion Reference Information Includes the Resource Set α

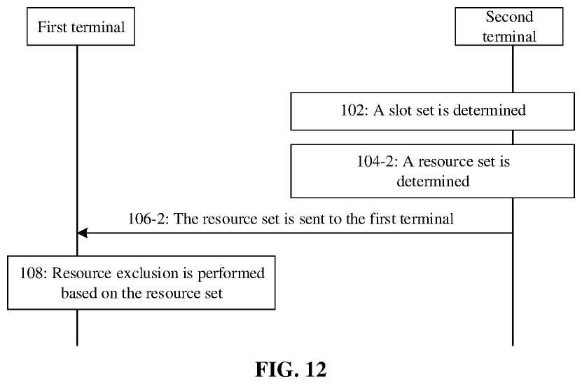

FIG. 12 illustrates a flowchart of a resource exclusion method provided by an exemplary embodiment of the disclosure. The embodiment is exemplified by application of the method to the second terminal (i.e., terminal 2) in FIG. 8. The above operation 104 may be replaced with operation 104-2, and the above operation 106 may be replaced with operation 106-2. The method includes the following operations.

At operation 104-2, the second terminal determines a resource set, the resource set including resources indicated or reserved by a target field in the first SCI detected in the slot set.

The second terminal may determine the resource set α based on the first SCI detected in the slot set A. In an example, the second terminal may determine the resource set α based on the resources indicated by the target field in the first SCI detected in the slot set A.

In an example, the second terminal may determine a first resource set, and resources in the first resource set may be determined based on target fields in all the first SCI detected in the slot set A. The target field includes at least one of a time-domain resource assignment field, a frequency-domain resource assignment field, or a resource reservation period field.

In an example, the second terminal may determine a second resource set, and resources in the second resource set may be determined based on target fields in part of the first SCI detected in the slot set A. The target field includes at least one of a time-domain resource assignment field, a frequency-domain resource assignment field, or a resource reservation period field. For example, the resources in the second resource set may be determined based on the target field in the target first SCI detected in the slot set A. SL-RSRP of a PSCCH where the target first SCI is located is greater than an RSRP threshold or SL-RSRP of a PSSCH scheduled by the target first SCI is greater than the RSRP threshold.

The above RSRP threshold may depend on the second terminal, or, the RSRP threshold may be a configured by network threshold, or the RSRP threshold may be a pre-configured threshold. The pre-configured threshold is a threshold set when delivery, or, the pre-configured threshold is a threshold that is configured by a previous network device and is still used by the second terminal after leaving cell coverage of the previous network device.

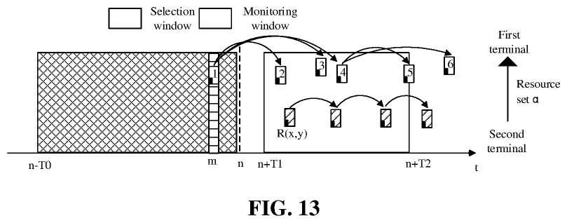

For example, the second terminal may add resources indicated or reserved by “Time resource assignment” and “Frequency resource assignment” fields in each piece of the first SCI detected in the slot set A to the resource set α. For example, in FIG. 13, the second terminal detects the first SCI in the PSCCH in resource 1 in the slot m, and adds the resources indicated or reserved by the “Time resource assignment” and “Frequency resource assignment” fields of the first SCI, namely resources 1, 2, and 3 or resources 2 and 3, to the resource set α.

For another example, the second terminal may add resources indicated or reserved by the “Time resource assignment”, “Frequency resource assignment”, and “Resource reservation period” fields in each piece of the first SCI detected in the slot set A to the resource set α. For example, in FIG. 13, the second terminal detects the first SCI in the PSCCH in the resource 1 in the slot m, and adds the resources indicated or reserved by the “Time resource assignment”, “Frequency resource assignment”, and “Resource reservation period” fields in the first SCI, namely the resources 1, 2, and 3, and resources 4, 5, and 6 for transmission of the next TB (corresponding to the indication), or resources 2, 3, 4, 5, and 6 (corresponding to the reservation), to the resource set α.

For another example, the second terminal may add resources indicated or reserved by the “Time resource assignment” and “Frequency resource assignment” fields in part of the first SCI detected in the slot set A to the resource set α.

For another example, the second terminal may add the resources indicated or reserved by the “Time resource assignment”, “Frequency resource assignment” and “Resource reservation period” fields in part of the first SCI detected in the slot set A to the resource set α.

At operation 106-2, the second terminal sends the resource set to the first terminal, the resource set being configured to assist the first terminal to perform resource exclusion.

The second terminal may indicate the resource set α to the first terminal. For example, in FIG. 13, the slot set A includes the slot m, the slot m being the slot in which the first terminal sends data. The second terminal may determine the resource set α based on the first SCI detected in the slot m in the above manner and indicate the resource set α to the first terminal.

The resource set α may be carried by at least one of following information: PC5-RRC signaling, MAC CE, first SCI, or second SCI. The first SCI is SCI carried in a PSCCH, and the second SCI is SCI carried in a PSSCH.

The second terminal may send the resource set α to the first terminal periodically. Or, in response to receiving the trigger information of the first terminal, the second terminal may send the resource set α to the first terminal.

At operation 108, the first terminal performs the resource exclusion based on the resource set.

The first terminal receives the resource set α and performs the resource exclusion process based on the resource set.

When the first terminal performs the resource exclusion, the first terminal may determine whether the resources in the resource set α overlap (fully overlap and partially overlap) with the resource R(x, y+j*Ptxlg), and if overlapping exists, the first terminal excludes the resource R(x,y) from the resource set A. For example, in FIG. 13, assuming that the resource set α indicated by the second terminal includes resources 1, 2, 3, 4, 5, and 6, the first terminal determines whether the six resources overlap with the resource R(x, y+j*Ptxlg) identified by the diagonal shadow, and if overlapping exists, the first terminal excludes the resource R(x,y) from the resource set A. That is, the first terminal determines whether to exclude candidate resources in the resource selection window based on the resources in the resource set α.

In conclusion, according to the method provided by the embodiment, through the cooperation between the first terminal and the second terminal, the second terminal can help the first terminal determine the resource set α needed for the resource exclusion process, and the first terminal may perform the resource exclusion based on the resource set α sent by the second terminal, so that the problem that the first terminal may exclude excessive resources when using all possible resource reservation periods for resource exclusion can be avoided, thereby enabling the first terminal to reserve enough available resources after the resource exclusion process, improving the utilization rate of communication resources. and improving the transmission success rate and transmission timeliness of the first terminal.

For a Case where the Resource Exclusion Reference Information Includes the Resource Reservation Period Set β and the Resource Set α

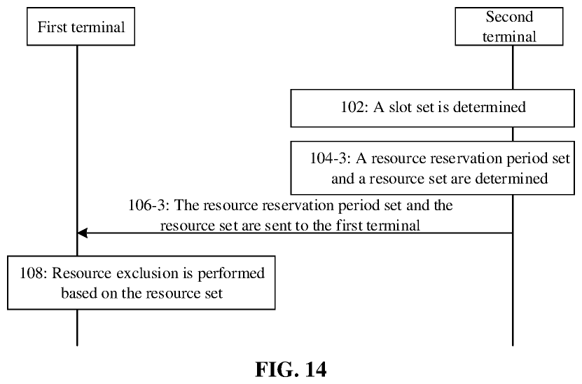

FIG. 14 illustrates a flowchart of a resource exclusion method provided by an exemplary embodiment of the disclosure. The embodiment is exemplified by the application of the method to the second terminal (i.e., terminal 2) in FIG. 8. The above operation 104 may be replaced with operation 104-3, and the above operation 106 may be replaced with operation 106-3. The method includes the following operations.

At operation 104-3, the second terminal determines the resource reservation period set and the resource set.

The process for the second terminal to determine the resource reservation period set may refer to the description of operation 104-1, and the process for the second terminal to determine the resource set may refer to the description of operation 104-2.

At operation 106-3, the second terminal sends the resource reservation period set and the resource set to the first terminal.

The second terminal may indicate the resource reservation period set β and the resource set α to the first terminal. For example, in FIG. 13, the slot set A includes slot m, the slot m being the slot in which the first terminal sends data. The second terminal determines the resource reservation period set β and the resource set α based on the first SCI detected in the slot m in the above manner and indicates the resource reservation period set β and the resource set α to the first terminal.

The resource reservation period set β and the resource set α are carried in at least one of the following information: PC5-RRC signaling, MAC CE, first SCI, or second SCI. The first SCI is SCI carried in a PSCCH, and the second SCI is SCI carried in a PSSCH.

The second terminal may send the resource reservation period set 3 and the resource set α to the first terminal periodically. Or, in response to receiving trigger information of the first terminal, the second terminal may send the resource reservation period set 3 and the resource set α to the first terminal.

At operation 108, the first terminal performs the resource exclusion based on the resource reservation period set and the resource set.

The first terminal receives the resource reservation period set and the resource set and performs the resource exclusion process based on the resource reservation period set and the resource set.

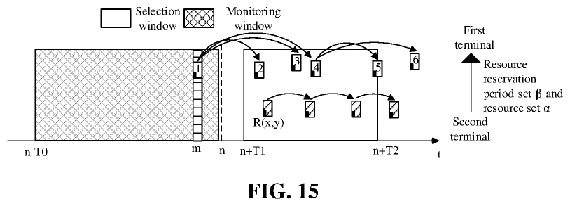

When performing the resource exclusion, the first terminal may determine resources indicated by certain first SCI in the resource set α, which is marked as Set A. The resource reservation period indicated by the same first SCI may be determined in the resource reservation period set β, which is marked as Prx. The first terminal assumes that the resource in Set A is reserved for Q periods with Prxlg as the period. For Q, if Prx is less than Tscal and n-m is less than or equal to Prxlg, Q=[Tscal/Prx] (representing rounding up), otherwise Q=1. Tscal is equal to T2. Prxlg is the number of logical slots converted from Prx. When the first terminal determines whether the resources in Set A and the corresponding resources of the above Q periods assumed to be reserved overlap (fully overlap and partially overlap) with the resource R(x, y+j*Ptxlg), and if overlapping exists, the first terminal excludes the resource R(x, y) from the resource set A. For example, in FIG. 15, the first terminal determines Set A as the resources 1, 2, and 3 in the resource set α, determines Prx in the resource reservation period set β, and calculates Q to be 1. Then, the first terminal assumes that Set A is reserved for one period, which refers to the resources 4, 5, and 6. Then, the first terminal determines whether the resources 1, 2, 3, 4, 5, and 6 overlap with the resource R(x, y+j*Ptxlg), and if overlapping exists, the first terminal excludes the resource R(x,y). The first terminal executes the above determination for each Set A determined by the resource set α, and performs resource exclusion. That is, the first terminal determines the resources and the resource reservation period indicated by the same first SCI in the resource set α and the resource reservation period set β, and determines whether to exclude candidate resources in the resource selection window based on the resources and resource reservation period indicated by the same first-SCI.

In an example, when the second terminal uses information bits to indicate the resource set α and the resource reservation period set β at the same time, indication may be performed in one of the following manners.
Manner 1: in an ascending order of bits, resources indicated by the “Time resource assignment” and “Frequency resource assignment” fields in first SCI 1 are indicated first, and then a resource reservation period indicated by the “Resource reservation period” field in the first SCI 1 is indicated. Similarly, resources indicated by the “Time resource assignment” and “Frequency resource assignment” fields in first SCI 2 are continued to be indicated first, and then a resource reservation period indicated by the “Resource reservation period” field in the first SCI 2 is indicated. Similarly, resources indicated by the “Time resource assignment” and “Frequency resource assignment” fields in first SCI 3 are continued to be indicated first, and then a resource reservation period indicated by the “Resource reservation period” field in the first SCI 3 is indicated. The ascending order of bits is an order of the bits from low to high.
Manner 2: in an ascending order of bits, a resource reservation period indicated by the “Resource reservation period” field in first SCI 1 is indicated first, and then resources indicated by the “Time resource assignment” and “Frequency resource assignment” fields in the first SCI 1 are indicated. Similarly, a resource reservation period indicated by the “Resource reservation period” field in first SCI 2 is continued to be indicated first, and then resources indicated by the “Time resource assignment” and “Frequency resource assignment” fields in the first SCI 2 are indicated. Similarly, a resource reservation period indicated by the “Resource reservation period” field in first SCI 3 is continued to be indicated first, and then resources indicated by the “Time resource assignment” and “Frequency resource assignment” fields in the first SCI 3 are indicated. The ascending order of bits is an order of the bits from low to high.

In conclusion, according to the method provided by the embodiment, through the cooperation between the first terminal and the second terminal, the second terminal can help the first terminal determine the resource reservation period set β and the resource set α needed for resource exclusion, and the first terminal performs the resource exclusion based on the resource reservation period set β and the resource set α sent by the second terminal, so that the problem that the first terminal may exclude excessive resources when using all possible resource reservation periods for resource exclusion can be avoided, thereby enabling the first terminal to reserve enough available resources after the resource exclusion process, improving the utilization rate of communication resources. and improving the transmission success rate and transmission timeliness of the first terminal.

### The Cooperative Mode Between UEs for Resource Reselection is as Follows.

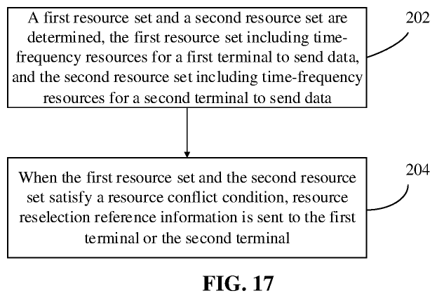

FIG. 17 illustrates a flowchart of a resource reselection method provided by an exemplary embodiment of the disclosure. The embodiment is exemplified by the application of the method to a cooperative terminal. The cooperative terminal may be the second terminal (i.e., terminal 2) or a third terminal (i.e., terminal 3) in FIG. 8. The method includes the following operations.

At operation 202, a first resource set is determined based on time-frequency resources for a first terminal to send data, and a second resource set is determined based on time-frequency resources for the second terminal to send data.

The first resource set φ includes: one or more time-frequency resources for the first terminal to send data.

The second resource set β includes: one or more time-frequency resources for the second terminal to send data.

The cooperative terminal and the second terminal may be the same terminal, or, the cooperative terminal and the second terminal may be different terminals.

In an example, the first resource set φ may include time-frequency resources determined in a past period of time by the cooperative terminal for the first terminal to send data. The above period of time may be a preset value specified by the standard, or may depend on implementation of the cooperative terminal, or may be configured by network or pre-configured.

In an example, the second resource set β may include: time-frequency resources determined in the past period of time by the cooperative terminal for the second terminal to send data.

At operation 204, in response to the first resource set φ and the second resource set β satisfying a resource conflict condition, the cooperative terminal sends resource reselection reference information to the first terminal or the second terminal.

The resource reselection reference information is configured to assist the first terminal or the second terminal in resource reselection. Or, the resource reselection reference information is configured to assist the first terminal or the second terminal in resource reselection. Or, the resource reselection reference information is used as reference information when the first terminal or the second terminal performs resource reselection. Or, the resource exclusion reference information is configured to trigger the first terminal or the second terminal to perform resource reselection, but whether the first terminal (or the second terminal) performs resource reselection is determined by the first terminal (or the second terminal).

The resource conflict condition is a condition to determine whether the first resource set φ conflicts or overlaps with the second resource set θ in at least one of time domain or frequency domain.

In an example, the resource conflict condition may include one or a combination of the following conditions.
Resources in the first resource set φ overlap with resources in the second resource set β in time-frequency domain.
The resources in the first resource set φ overlap with the resources in the second resource set β in time domain.
more than k resources in the first resource set φ and the second resource set θ in time-frequency domain overlap.
more than k resources in the first resource set φ and the second resource set θ in time domain overlap.

The k may be a preset value specified by the communication standard, or may depend on implementation of the cooperative terminal, or may be configured by network or pre-configured.
more than f % resources in the first resource set φ and the second resource set θ in time-frequency domain overlap.
more than f % resources in the first resource set φ and the second resource set θ in time domain overlap.

The f may be a preset value specified by the communication standard, or may depend on implementation of the cooperative terminal, or may be configured by network or pre-configured.
Resources in the first resource set φ periodically overlap with resources in the second resource set β in time-frequency domain.
Resources in the first resource set φ periodically overlap with resources in the second resource set θ in time domain.
Resources in the first resource set φ continuously overlap with resources in the second resource set θ in time-frequency domain.
Resources in the first resource set φ continuously overlap with resources in the second resource set θ in time domain.

For example, N consecutive resources in time domain overlap in time-frequency domain or time domain, or N resources overlap in time-frequency domain or time-domain within a time range [t1, t2]. The above N, t1, and t2 may be preset values specified by the standard, or may depend on implementation of the cooperative terminal, or may be configured by network or pre-configured.

In an example, on the basis of the above resource conflict condition, the resource conflict condition may further include one or a combination of following conditions.
The resource reservation periods used by the first terminal and the second terminal are the same or in a multiple relationship.

For example, the cooperative terminal knows the resource reservation periods used by the first terminal and the second terminal by decoding first SCI of the first terminal and the second terminal.
The first terminal and the second terminal belong to the same group in multicast.

For example, the cooperative terminal may determine, by decoding second SCI of the first terminal and the second terminal, whether the first terminal and the second terminal belong to the same group based on “Destination ID” fields. When the “Destination ID” fields are the same group ID, the first terminal and the second terminal belong to the same group.
The first terminal and the second terminal belong to the same Zone.

For example, the cooperative terminal may determine, by decoding the second SCI of the first terminal and the second terminal, whether the first terminal and the second terminal belong to the same zone through “Zone ID” fields. When the “Zone ID” fields are the same, the first terminal and the second terminal belong to the same zone.

The first terminal is a receiving end of the second terminal or the second terminal is a receiving end of the first terminal.

Taking the former as an example, the cooperative terminal may decode the second SCI of the first terminal and the second terminal. Based on the “Source ID” field of the second SCI sent by the first terminal and the “Destination ID” field of the second SCI sent by the second terminal, the cooperative terminal may determine whether the first terminal is the receiving end of the second terminal. Or, based on the “Zone ID” field of the second SCI sent by the first terminal and the “Zone ID” and “communication range requirement” fields of the second SCI sent by the second terminal, the cooperative terminal may determine whether the first terminal is the receiving end of the second terminal.

The cooperative terminal may send resource reselection reference information to the first terminal or the second terminal. In an example, the resource reselection reference information is configured to trigger the first terminal or the second terminal to perform resource reselection.

In an example, in a case where first priority is lower than second priority, the resource reselection reference information may be sent to the first terminal, and in a case where the first priority is higher than the second priority, the resource reselection reference information may be sent to the second terminal.

The first priority is priority of data sent or to be sent by the first terminal, and the second priority is priority of data sent or to be sent by the second terminal. Optionally, the first priority may be determined based on the first SCI most recently sent by the first terminal. The second priority may be determined based on the first SCI most recently sent by the second terminal.

The resource reselection reference information may be carried by at least one of following information: PC5-RRC signaling, an MAC CE, the first SCI, or the second SCI. The first SCI is SCI carried in a PSCCH, and the second SCI is SCI carried in a PSSCH.

In a possible design, the resource reselection reference information may include a resource indication of a target resource in the first resource set. The target resource is a resource that overlaps with resources in the second resource set in time-frequency domain or time domain.

In conclusion, according to the method provided by the embodiment, through the cooperation between the first terminal and the second terminal, the cooperative terminal can help the first terminal determine the reference information needed in the resource reselection process, and the first terminal performs the resource reselection process according to the reference information sent by the cooperative terminal, which may avoid persistent or periodic collisions, solve the half-duplex problem, and improve the communication reliability.

In an optional embodiment based on FIG. 17, the cooperative terminal has two implementation possibilities.
The cooperative terminal and the second terminal are different terminals.
The cooperative terminal and the second terminal are the same terminal.

For a case where the cooperative terminal and the second terminal are different terminals, the following embodiment is provided.

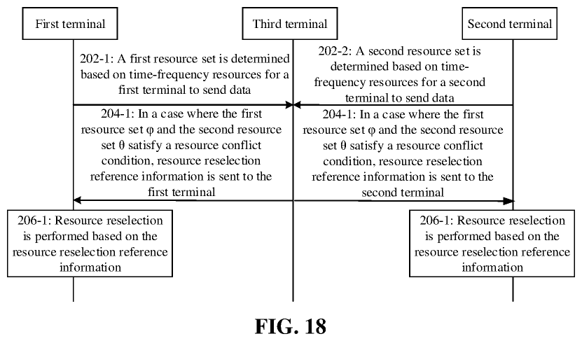

FIG. 18 illustrates a flowchart of a resource reselection method provided by an exemplary embodiment of the disclosure. The embodiment is exemplified by the application of the method to a cooperative terminal. The cooperative terminal may be a third terminal (i.e., terminal 3) in FIG. 8. The method includes the following operations.

At operation 202-1, the third terminal determines a first resource set based on time-frequency resources for a first terminal to send data, and determines a second resource set based on time-frequency resources for a second terminal to send data.

The first resource set φ may include: one or more time-frequency resources for the first terminal to send data.

The second resource set β may include: one or more time-frequency resources for the second terminal to send data.

The third terminal may determine time-frequency resources for the first terminal to send data, marked as first resource set φ. The first resource set φ may include: one or more time-frequency resources for the first terminal to send data. In an example, the third terminal may determine time-frequency resources for the first terminal to send data by receiving the data sent by the first terminal; or, the third terminal may determine time-frequency resources for the first terminal to send data by decoding first SCI and second SCI sent by the first terminal. For example, in a certain slot, the third terminal may decode the first SCI sent by a UE, and decode corresponding second SCI sent by the UE according to an indication of the first SCI. If a “Source ID” in the second SCI indicates that the UE is the first terminal, the UE is the first terminal. The third terminal may determine time-frequency resources for the first terminal to send data based on the resources indicated in the first SCI.

Similarly, the third terminal may determine the time-frequency resources for the second terminal to send data, marked as second resource set θ. The second resource set θ may include: one or more time-frequency resources for the second terminal to send data.

In an example, the first resource set φ may include time-frequency resources determined in the past period of time by the third terminal for the first terminal to send data. The above period of time may be a preset value specified by the standard, may depend on implementation of the third terminal, or may be configured by network or pre-configured.

In an example, the second resource set β may include: time-frequency resources determined in the past period of time by the third terminal for the second terminal to send data.

At operation 204-1, in a case where the first resource set φ and the second resource set θ satisfy a resource conflict condition, the third terminal sends resource reselection reference information to the first terminal or the second terminal.

The resource conflict condition is a condition to determine whether the first resource set φ conflicts or overlaps with the second resource set β in at least one of time domain or frequency domain.

In an example, the specific type of the resource conflict condition is as described in operation 204 and will not be elaborated.

The third terminal may send the resource reselection reference information to the first terminal or the second terminal. In an example, the resource reselection reference information is configured to trigger the first terminal or the second terminal to perform resource reselection.

In an example, in a case where first priority is lower than second priority, the third terminal may send the resource reselection reference information to the first terminal, and in a case where the first priority is higher than the second priority, the third terminal may send the resource reselection reference information to the second terminal.

The first priority is priority of data sent or to be sent by the first terminal, and the second priority is priority of data sent or to be sent by the second terminal. Optionally, the first priority may be determined based on the first SCI most recently sent by the first terminal. The second priority may be determined based on the first SCI most recently sent by the second terminal.

The resource reselection reference information may be carried by at least one of following information: PC5-RRC signaling, an MAC CE, the first SCI, or the second SCI. The first SCI is SCI carried in a PSCCH, and the second SCI is SCI carried in a PSSCH.

The second terminal may send the resource reselection reference information to the first terminal periodically. Or, in response to receiving trigger information of the first terminal, the second terminal may send the resource reselection reference information to the first terminal.

In a possible design, in a case where the resource reselection reference information is sent to the first terminal, the resource reselection reference information may include a resource indication of a target resource in the first resource set. The target resource is a resource that overlaps with resources in the second resource set in time-frequency domain or time domain. Similarly, in a case where the resource reselection reference information is sent to the second terminal, the resource reselection reference information includes a resource indication of a target resource in the second resource set. The target resource is a resource that overlaps with resources in the first resource set in time-frequency domain or time domain.

In a possible design, the resource reselection reference information is configured to instruct the first terminal to reselect part of the selected resources in the semi-continuous transmission.

At operation 206-1, the first terminal or the second terminal performs resource reselection based on the resource reselection reference information.

The first terminal or the second terminal may determine a resource selection window and a resource monitoring window for resource exclusion, determine a candidate resource set, and select resources from the candidate resource set to send data.

For example, when the first terminal does not take semi-continuous transmission, the first terminal may send resources 1, 2, and 3, and the third terminal may indicate through the resource reselection reference information that there is time-frequency domain overlapping or time-domain overlapping at resource 2, and then the first terminal may reselect resources reserved by the first SCI in the resource 2 only.

For another example, when the first terminal takes semi-continuous transmission, the first terminal may send resources 1, 2, and 3 (period 1), resources 4, 5, and 6 (period 2), and resources 7, 8, and 9 (period 3), where the first SCI in the period 1 reserves resources in the period 2, and the first SCI in the period 2 reserves resources in the period 3. The third terminal may indicate through the resource reselection reference information that overlapping in time-frequency domain or time domain takes place at the resources 1, 4, and 7, and then the first terminal may reselect resources reserved by the first SCI in the resource 7.

For another example, the third terminal may directly use the resource reselection reference information to instruct the first terminal to perform resource reselection on all the selected resources.

In conclusion, according to the method provided by the embodiment, through the cooperation between the first terminal and the second terminal, the third terminal can help the first terminal determine the reference information needed for the resource reselection process, and the first terminal may perform the resource reselection process according to the reference information sent by the third terminal, which may avoid persistent or periodic collisions, solve the half-duplex problem, and improve the communication reliability.

For a case where the cooperative terminal and the second terminal are the same terminal, the following embodiment is provided.

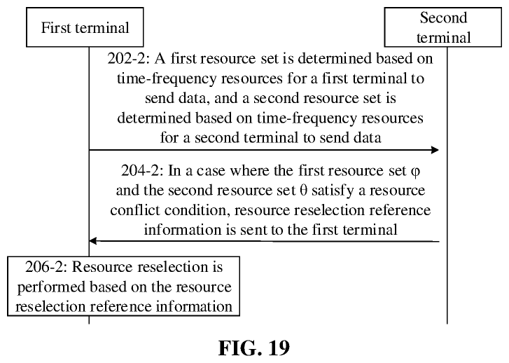

FIG. 19 illustrates a flowchart of a resource reselection method provided by an exemplary embodiment of the disclosure. The embodiment is exemplified by the application of the method to a cooperative terminal. The cooperative terminal may be a second terminal (i.e., terminal 2) in FIG. 8. The method includes the following operations.

At operation 202-2, the second terminal determines a first resource set based on time-frequency resources for a first terminal to send data, and determines a second resource set based on time-frequency resources for the second terminal to send data.

The first resource set φ may include: one or more time-frequency resources for the first terminal to send data.

The second resource set β may include: one or more time-frequency resources for the second terminal to send data.

The second terminal may determine time-frequency resources for the first terminal to send data, marked as first resource set φ. The first resource set φ may include: one or more time-frequency resources for the first terminal to send data. In an example, the second terminal may determine the time-frequency resources for the first terminal to send data by receiving the data sent by the first terminal; or, the second terminal may determine time-frequency resources for the first terminal to send data by decoding first SCI and second SCI sent by the first terminal. For example, in a certain slot, the second terminal may decode the first SCI sent by a UE, and decode the corresponding second SCI sent by the UE according to an indication of the first SCI. If a “Source ID” in the second SCI indicates that the UE is the first terminal, the UE is determined as the first terminal. The second terminal may determine time-frequency resources for the first terminal to send data based on the resources indicated in the first SCI.

The second resource set β may include: one or more time-frequency resources for the second terminal to send data.

In an example, the first resource set φ may include time-frequency resources determined in the past period of time by the second terminal for the first terminal to send data. The above period of time may be a preset value specified by the standard, may depend on implementation of the second terminal, or may be configured by network or pre-configured.

In an example, the second resource set β may include: time-frequency resources determined in the past period of time by the third terminal for the second terminal to send data. The above period of time may be a preset value specified by the standard, may depend on implementation of the second terminal, or may be configured by network or pre-configured.

At operation 204-2, in a case where the first resource set φ and the second resource set θ satisfy a resource conflict condition, the second terminal sends resource reselection reference information to the first terminal.

The resource conflict condition is a condition to determine whether the first resource set φ conflicts or overlaps with the second resource set β in at least one of time domain or frequency domain.

In an example, the specific condition type of the resource conflict condition is as described in operation 204 and will not be elaborated.

The second terminal may send the resource reselection reference information to the first terminal. In an example, the resource reselection reference information is configured to trigger the first terminal to perform resource reselection.

In an example, in a case where first priority is lower than second priority, the second terminal may send the resource reselection reference information to the first terminal.

The first priority is priority of data sent or to be sent by the first terminal, and the second priority is priority of data sent or to be sent by the second terminal. Optionally, the first priority may be determined based on the first SCI most recently sent by the first terminal.

The resource reselection reference information may be carried by at least one of following information: PC5-RRC signaling, an MAC CE, the first SCI, or the second SCI. The first SCI is SCI carried in a PSCCH, and the second SCI is SCI carried in a PSSCH.

In a possible design, the resource reselection reference information may include a resource indication of a target resource in the first resource set. The target resource is a resource that overlaps with resources in the second resource set in time-frequency domain or time domain.

At operation 206-2, the first terminal performs resource reselection based on the resource reselection reference information.

The first terminal may determine a resource selection window and a resource monitoring window for resource exclusion, determine a candidate resource set, and select resources from the candidate resource set to send data.

For example, when the first terminal does not take semi-continuous transmission, the first terminal may send resources 1, 2, and 3, and the second terminal may indicate through the resource reselection reference information that there is overlapping in time-frequency domain or time domain at resource 2, and then the first terminal may reselect resources reserved by the first SCI in the resource 2 only.

For another example, when the first terminal takes semi-continuous transmission, the first terminal may send resources 1, 2, and 3 (period 1), resources 4, 5, and 6 (period 2), and resources 7, 8, and 9 (period 3), where the first SCI in the period 1 reserves resources in the period 2, and the first SCI in the period 2 reserves resources in the period 3. The second terminal may indicate through the resource reselection reference information that overlapping in time-frequency domain or time domain takes place at the resources 1, 4, and 7, and then the first terminal may reselect resources reserved by the first SCI in the resource 7.

For another example, the second terminal may directly use the resource reselection reference information to instruct the first terminal to perform resource reselection on all the selected resources.

In conclusion, according to the method provided by the embodiment, through the cooperation between the first terminal and the second terminal, the second terminal can help the first terminal determine reference information needed for resource reselection, and the first terminal may perform the resource reselection according to the reference information sent by the second terminal, which may avoid persistent or periodic collisions, solve the half-duplex problem, and improve the communication reliability.

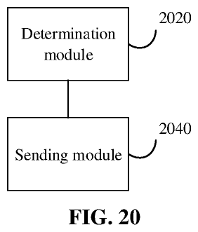

FIG. 20 is a block diagram of a resource reselection apparatus provided by an exemplary embodiment of the disclosure. The apparatus is applied for a second terminal, or the apparatus is implemented as the second terminal or a part of the second terminal. The apparatus includes a determination module 2020 and a sending module 2040.

The determination module 2020 is configured to determine a slot set, the slot set including slots for a first terminal to send data.

The determination module 2020 is further configured to determine resource exclusion reference information based on first SCI detected in the slot set.

The sending module 2040 is configured to send the resource exclusion reference information to the first terminal, the resource exclusion reference information being configured to assist the first terminal in resource exclusion.

In an optional design of the disclosure, the resource exclusion reference information may include:
a resource reservation period set;
and/or,
a resource set, including resources indicated or reserved by the first SCI.

In an optional design of the disclosure, the resource exclusion reference information may include the resource reservation period set.

The determination module 2020 may be further configured to determine a first resource reservation period set, the first resource reservation period set including values indicated by resource reservation period fields in all the first SCI detected in the slot set, or determine a second resource reservation period set, the second resource reservation period set including values indicated by resource reservation period fields in part of the first SCI detected in the slot set.

In an optional design of the disclosure, the second resource reservation period set may include:
a value indicated by a resource reservation period field in target first SCI detected in the slot set.

SL-RSRP of a PSCCH where the target first SCI is located is greater than an RSRP threshold or SL-RSRP of a PSSCH scheduled by the target first SCI is greater than the RSRP threshold.

In an optional design of the disclosure, the resource exclusion reference information may include the resource set.

The determination module 2020 may be further configured to determine a first resource set, resources of which are determined based on target fields in all the first SCI detected in the slot set, the target field including at least one of a time-domain resource assignment field, a frequency-domain resource assignment field, or a resource reservation period field; or, determine a second resource set, resources of which are determined based on target fields in part of the first SCI detected in the slot set, the target field including at least one of a time-domain resource assignment field, a frequency-domain resource assignment field, or a resource reservation period field.

In an optional design of the disclosure, the resources in the second resource set may be determined based on a target field in target first SCI detected in the slot set.

The SL-RSRP of the PSCCH where the target first SCI is located is greater than the RSRP threshold or the SL-RSRP of the PSSCH scheduled by the target first SCI is greater than the RSRP threshold.

In an optional design of the disclosure, the RSRP threshold may be a threshold configured by a network device, or the RSRP threshold may be a pre-configured threshold.

In an optional design of the disclosure, the resource exclusion reference information may be carried by at least one of following information:
PC5-RRC signaling;
an MAC CE;
the first SCI; or
second SCI.

The first SCI is SCI carried in a PSCCH, and the second SCI is SCI carried in a PSSCH.

In an optional design of the disclosure, the sending module 2040 may be further configured to send the resource exclusion reference information to the first terminal periodically, or, send, in response to receiving trigger information of the first terminal, the resource exclusion reference information to the first terminal.

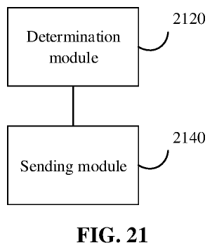

FIG. 21 is a block diagram of a resource reselection apparatus provided by an exemplary embodiment of the disclosure. The apparatus is applied for a cooperative terminal, or the apparatus is implemented as the cooperative terminal or a part of the cooperative terminal. The apparatus includes a determination module 2121 and a sending module 2140.

The determination module 2121 is configured to determine a first resource set and a second resource set, the first resource set including time-frequency resources for the first terminal to send data, and the second resource set including time-frequency resources for the second terminal to send data.

The sending module 2140 is configured to send, when the first resource set and the second resource set satisfy a resource conflict condition, the resource reselection reference information to the first terminal.

In an optional design of the disclosure, the resource conflict condition may include one or a combination of the following conditions:
Resources in the first resource set overlap with resources in the second resource set in time-frequency domain;
Resources in the first resource set overlap with resources in the second resource set in time domain;
More than K resources in the first resource set and the second resource set overlap in time-frequency domain;
More than K resources in the first resource set and the second resource set overlap in time domain;
More than f % resources in the first resource set and the second resource set overlap in time-frequency domain;
More than f % resources in the first resource set and the second resource set overlap in time domain;
Resources in the first resource set periodically overlap with resources in the second resource set in time-frequency domain;
Resources in the first resource set periodically overlap with resources in the second resource set in time domain;
Resources in the first resource set continuously overlap with resources in the second resource set in time-frequency domain; and
Resources in the first resource set periodically overlap with resources in the second resource set in time domain.

In an optional design of the disclosure, the resource conflict condition may further include one or a combination of the following conditions:
Resource reservation periods used by the first terminal and the second terminal are the same or in a multiple relationship;
The first terminal and the second terminal belong to a same group in multicast;
The first terminal and the second terminal belong to a same Zone; and
The first terminal is a receiving end of the second terminal or the second terminal is a receiving end of the first terminal.

In an optional design of the disclosure, the sending module 2140 may be further configured to send, in a case where first priority is lower than second priority, the resource reselection reference information to the first terminal. The first priority is priority of data sent or to be sent by the first terminal, and the second priority is priority of data sent or to be sent by the second terminal.

In an optional design of the disclosure, the first priority may be determined based on the first SCI most recently sent by the first terminal.

In an optional design of the disclosure, the cooperative terminal and the second terminal may be different terminals.

The second priority may be determined based on the first SCI most recently sent by the second terminal.

In an optional design of the disclosure, the resource reselection reference information may be carried by at least one of following information:
PC5-RRC signaling;
an MAC CE;
the first SCI; or
second SCI.

The first SCI is SCI carried in a PSCCH, and the second SCI is SCI carried in a PSSCH.

In an optional design of the disclosure, the cooperative terminal and the second terminal may be different terminals, or the cooperative terminal and the second terminal may be the same terminal.

In an optional design of the disclosure, the resource reselection reference information may be configured to instruct the first terminal to reselect part of the selected resources in the semi-continuous transmission.

In an optional design of the disclosure, the resource reselection reference information may include a resource indication of a target resource in the first resource set. The target resource is a resource that overlaps with resources in the second resource set in time-frequency domain or time domain.

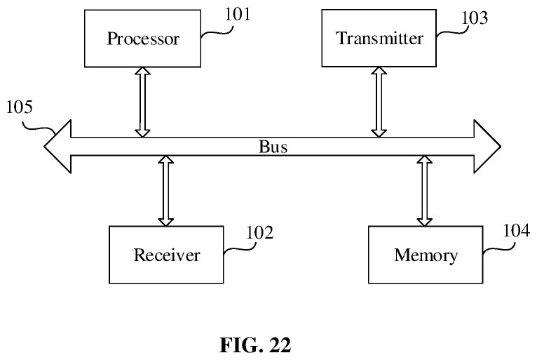

FIG. 22 illustrates a schematic structural diagram of a communication device (a second terminal or a cooperative terminal) provided by an exemplary embodiment of the disclosure. The communication device includes: a processor 101, a receiver 102, a transmitter 103, a memory 104, and a bus 105.

The processor 101 includes one or more processing cores. The processor 101 may implement various functional applications and information processing by running software programs and modules.

The receiver 102 and the transmitter 103 may be implemented as a communication component, which may be a communication chip.

The memory 104 is connectable to the processor 101 through the bus 105.

The memory 104 may be configured to store at least one instruction, and the processor 101 is configured to execute the at least one instruction to implement the operations of the above method embodiments.

In addition, the memory 104 may be implemented by any type of volatile or non-volatile memory devices, or a combination thereof. The volatile or non-volatile memory devices include, but are not limited to: a magnetic disk or an optical disk, an Electrically-Erasable Programmable Read Only Memory (EEPROM), an Erasable Programmable Read Only Memory (EPROM), a Static Random Access Memory (SRAM), a Read-Only Memory (ROM), a magnetic memory, a flash memory, and a Programmable ROM (PROM).

In an exemplary embodiment, a computer-readable storage medium is further provided. At least one instruction, at least one program, a code set or an instruction set are stored in the computer-readable storage medium. The at least one instruction, the at least one program, the code set or the instruction set are loaded and executed by a processor to implement the resource exclusion method or the resource reselection method provided by the above method embodiments.

In an exemplary embodiment, a computer program product or a computer program is further provided. The computer program product or the computer program includes a computer instruction. The computer instruction is stored in a computer-readable storage medium, a processor of a communication device reads the computer instruction from the computer-readable storage medium, and the processor executes the computer instruction, so that the computer device executes the resource exclusion method or the resource reselection method as described in the above aspects.

Those of ordinary skill in the art should know that all or part of the steps of the above-mentioned embodiments may be implemented by hardware or related hardware instructed through a program, the program may be stored in the computer-readable medium, and the above-mentioned storage medium may be a read-only memory, a magnetic disk or a compact disc.

The above is only the optional embodiments of the disclosure and is not intended to limit the disclosure. Any modifications, equivalent replacements, improvements and the like made within the spirit and principle of the disclosure shall fall within the scope of protection of the disclosure.

1-9. (canceled)

10. A resource reselection method, applied by a cooperative terminal, comprising:
determining a first resource set and a second resource set, the first resource set comprising time-frequency resources for a first terminal to send data, and the second resource set comprising time-frequency resources for a second terminal to send data; and
when the first resource set and the second resource set satisfy a resource conflict condition, sending resource reselection reference information to the first terminal.

11. The method of claim 10, wherein the resource conflict condition comprises that:
resources in the first resource set overlap with resources in the second resource set in time-frequency domain.

12. The method of claim 11 wherein
the second terminal is a receiving end of the first terminal,
wherein the second terminal determines the time-frequency resources for the second terminal to send data by decoding first Sidelink Control Information (SCI) and second SCI which are both sent by the first terminal.

13. The method of a claim 10, wherein the sending resource reselection reference information to the first terminal comprises:
in a case where first priority is lower than second priority, sending the resource reselection reference information to the first terminal;
wherein the first priority is priority of data sent or to be sent by the first terminal, and the second priority is priority of data sent or to be sent by the second terminal.

14. The method of claim 13, wherein the first priority is determined based on first Side Link Control Information (SCI) most recently sent by the first terminal.

15. The method of claim 13, wherein the cooperative terminal and the second terminal are different terminals; and
the second priority is determined based on first SCI most recently sent by the second terminal.

16. (canceled)

17. The method of claim 10, wherein the cooperative terminal and the second terminal are different terminals, or the cooperative terminal and the second terminal are the same terminal.

18. The method of claim 10, wherein the resource reselection reference information comprises a resource indication of a target resource in the first resource set, wherein the target resource is a resource that overlaps with resources in the second resource set in time-frequency domain or time domain.

19-27. (canceled)

28. A resource reselection apparatus, applied for a cooperative terminal, comprising:
a processor; and
a transceiver connected to the processor:
wherein the processor is configured to determine a first resource set and a second resource set, the first resource set comprising time-frequency resources for a first terminal to send data, and the second resource set comprising time-frequency resources for a second terminal to send data; and
the transceiver is configured to send, when the first resource set and the second resource set satisfy a resource conflict condition, resource reselection reference information to the first terminal.

29. The apparatus of claim 28, wherein the resource conflict condition further comprises that:
resources in the first resource set overlap with resources in the second resource set in time-frequency domain.

30. The apparatus of any one of claim 29, wherein
the second terminal is a receiving end of the first terminal,
wherein the second terminal determines the time-frequency resources for the second terminal to send data by decoding first Sidelink Control Information (SCI) and second SCI which are both sent by the first terminal.

31. The apparatus of any one of elemis claim 28, wherein the transceiver is further configured to send, in a case where first priority is lower than second priority, the resource reselection reference information to the first terminal, wherein the first priority is priority of data sent or to be sent by the first terminal, and the second priority is priority of data sent or to be sent by the second terminal.

32. The apparatus of claim 31, wherein the first priority is determined based on first Side Link Control Information (SCI) most recently sent by the first terminal.

33. The apparatus of claim 31, wherein the cooperative terminal and the second terminal are different terminals; and
the second priority is determined based on the first SCI most recently sent by the second terminal.

34. (canceled)

35. The apparatus of any one of claim 28, wherein the cooperative terminal and the second terminal are different terminals, or the cooperative terminal and the second terminal are the same terminal.

36. The apparatus of any one of claim 28, wherein the resource reselection reference information comprises a resource indication of a target resource in the first resource set, wherein the target resource is a resource that overlaps with resources in the second resource set in time-frequency domain or time domain.

37-40. (canceled)

41. The method of claim 10, further comprising:
in a case where first priority is higher than second priority, sending the resource reselection reference information to the second terminal;
wherein the first priority is priority of data sent or to be sent by the first terminal, and the second priority is priority of data sent or to be sent by the second terminal.

42. The method of claim 10, wherein the resource reselection reference information is configured to trigger the second terminal to perform resource reselection, and the second terminal performs the resource reselection based on the resource reselection reference information,
wherein the second terminal determines a resource selection window and a resource monitoring window for resource exclusion, determines a candidate resource set, and selects resources from the candidate resource set to send data.

43. The apparatus of claim 28, wherein the transceiver is further configured to send, in a case where first priority is higher than second priority, the resource reselection reference information to the second terminal, wherein the first priority is priority of data sent or to be sent by the first terminal, and the second priority is priority of data sent or to be sent by the second terminal.

44. The apparatus of claim 28, wherein the resource reselection reference information is configured to trigger the second terminal to perform resource reselection, and the second terminal performs the resource reselection based on the resource reselection reference information,
wherein the second terminal determines a resource selection window and a resource monitoring window for resource exclusion, determines a candidate resource set, and selects resources from the candidate resource set to send data.
